(19) United States
(12) Patent Application Publication
(10) Pub. No.: US 2022/0410121 A1
(43) Pub. Date: Dec. 29, 2022

(54) Metal-Organic Material Extrudates, Methods of Making, and Methods of Use

(71) Applicant: ExxonMobil Technology and Engineering Company, Annandale, NJ (US)

(72) Inventors: Jean W. Beeckman, Annandale, NJ (US); Nadya A. Hrycenko, Clinton, NJ (US); Aaron W. Peters, New Hope, PA (US); Patrick J. Hill, Long Valley, NJ (US); Matthew T. Kapelewski, Flemington, NJ (US)

(21) Appl. No.: 17/779,332

(22) PCT Filed: Jul. 27, 2020
(86) PCT No.: PCT/US2020/043767

§ 371 Date: May 24, 2022

Related U.S. Application Data
(60) Provisional application No. 62/940,282, filed on Nov. 26, 2019.

(51) Int. Cl. B01J 20/22; B01J 20/28; B01J 20/30

(52) U.S. Cl. CPC B01J 20/226; B01J 20/28011; B01J 20/2803; B01J 20/2808; B01J 20/28083; B01J 20/28088; B01J 20/28057; B01J 20/3042; B01J 20/3007

(57) ABSTRACT

The present disclosure relates to compositions including metal-organic framework materials and a polymeric binder. The compositions may have a crush strength of about 2.5 lb-force or greater. The present disclosure also relates to processes for producing metal-organic framework extrudates. Processes may include mixing a metal-organic framework material, a polymeric binder, and optionally a solvent to form a mixture. The process may also include extruding the mixture to form a metal-organic framework extrudate.

### FIELD

The present disclosure relates to metal-organic material extrudates, specifically, extrudates with improved mechanical strength including polymeric binders. The present disclosure also relates to methods of making metal-organic material extrudates, and methods of use.

### BACKGROUND

Materials displaying a large internal surface area, defined by pores or channels, are of predominant interest for applications in catalysis, for absorption and/or adsorption techniques, ion exchanging, chromatography, storage and/or uptake of substances, among others.

Among the many various strategies to create micro- and/or mesoporous active materials, the formation of metal-organic frameworks (MOFs) using metal ions and molecular organic building blocks is particularly advantageous. MOF materials provide many advantages including: (i) larger pore sizes can be realized than for the zeolites used presently; (ii) the internal surface area is larger than for porous materials used presently; (iii) pore size and/or channel structure can be tailored over a large range; and/or (iv) the organic framework components of the internal surface can be functionalized easily.

MOFs are hybrid materials composed of metal ions or clusters coordinated to multi-topic organic linkers that self-assemble to form a coordination network. These materials have wide-ranging potential uses in many different applications including gas storage, gas separation, catalysis, sensing, environmental remediation, etc. In many of these applications, shaped particles are often used to avoid large pressure drops in a reactor bed or to ease material handling. Shaping of materials can embody various forms such as extrudates, rings, pellets, spheres, etc. In order to decrease the generation of fines during shipping or during application, shaped particles must have sufficient mechanical strength to withstand compressive force generated by process conditions or by the pressure exerted by the weight of the catalyst bed.

Due to the relative mechanical instability of some MOFs, attempts at shaping MOFs have 1) degraded the crystallinity and porosity of the material, 2) lacked sufficient mechanical strength to meet the specifications needed by a given application, and/or 3) involve prohibitively high percentages of binders (decreasing the amount of active material in the shaped body). Additionally, the use of liquid reagents, including water, may cause loss of mechanical strength in MOFs that do not include a binder.

There is a need for MOF extrudates having improved mechanical strength without degraded crystallinity or porosity of the MOF and without requiring high percentages of binder.

### SUMMARY

The present disclosure relates to compositions including metal-organic framework materials and a polymeric binder. The compositions may have a crush strength of about 2.5 lb-force or greater. The present disclosure also relates to processes for producing metal-organic framework extrudates. Processes may include mixing a metal-organic framework material, a polymeric binder, and optionally a solvent to form a mixture. The process may also include extruding the mixture to form a metal-organic framework extrudate.

### BRIEF DESCRIPTION OF THE DRAWINGS

FIG. 1 is a graph illustrating adsorption of N₂ and XRD data of HKUST-1, a MOF including copper and 1,3,5-benzenetricarboxylic acid.

FIG. 2 is a graph illustrating adsorption of N₂ and XRD data of UiO-66, a MOF including [Zr₆O₄(OH)₄] and 1,4-benzenedicarboxylic acid.

FIG. 3 is a graph illustrating adsorption of N₂ and XRD data of ZIF-8, a MOF including zinc and imidazole.

FIG. 4 is a graph illustrating adsorption of N₂ and XRD data of MIL-100(Fe), a MOF including iron and 1,3,5-benzenetricarboxylic acid.

FIG. 5 is a graph illustrating adsorption of CO₂ and XRD data of ZIF-7, a MOF including zinc and imidazole.

### DETAILED DESCRIPTION

It has been discovered that the addition of various polymer-based binders (such as hydroxypropyl methylcellulose, polyvinylpyrollidone, poly(allylamine), sulfonated polytetrafluoroethylene, or polyvinyl acetate) improves the mechanical stability of MOF extrudates. Additionally, small quantities of these polymeric binders (about 20 wt % or less) increases the crush strength of the extrudate considerably while preserving the high crystallinity and surface area of the MOF. These binders are shown to improve the mechanical stability of MOFs with various metal nodes, pore structures, and crystallite sizes. As a result, this discovery is applicable to a variety of MOF crystallites and a variety of polymeric binders. Overall, the addition of the polymeric binders may provide MOF materials with crush strength for use in many industrial processes.

A MOF extrudate includes one or more metal organic-framework materials processed with a binder including at least one polymer.

A MOF material may include a metal or metalloid and an organic ligand capable of coordination with the metal or metalloid. In some embodiments, MOF coordination networks of organic ligands and metals (or metalloids) form porous three-dimensional structures. MOFs may also include ZIFs (or Zeolitic Imidazolate Frameworks), MILs (or Matériaux de l'Institut Lavoisier), and IRMOFs (or IsoReticular Metal Organic Frameworks), alone or combination with other MOFs. In some embodiments, the MOF is selected from: HKUST-1, MOF-74, MIL-100, ZIF-7, ZIF-8, ZIF-90, UiO-66, UiO-67, MOF-808 or MOF-274.

In some embodiments, the MOF is prepared via combination of an organic ligand and a metal or metalloid as described below. For example, MOF-274 is a combination of Mg²⁺, Mn²⁺, Fe²⁺, Zn²⁺, Ni²⁺, Cu²⁺, Co²⁺ or combinations thereof with 4,4′-dihydroxy-(1,1′-biphenyl)-3,3′-dicarboxylic acid. Additionally, MOF-274 may include amines coordinated to the metal sites within its structure.

### Organic Ligands

The organic ligand includes a ligand, which may include ligands that are monodentate, bidentate, multi-dentate, or combination(s) thereof. The organic ligand is capable of coordination with the metal ion, in principle all compounds can be used which are suitable for such coordination. Organic ligands including at least two centers, which are capable to coordinate the metal ions of a metal salt, or metals or metalloids. In some embodiments, an organic ligand includes: i) an alkyl group substructure, having from 1 to 10 carbon atoms, ii) an aryl group substructure, having from 1 to 5 aromatic rings, iii) an alkyl or aryl amine substructure, consisting of alkyl groups having from 1 to 10 carbon atoms or aryl groups having from 1 to 5 aromatic rings, where the substructures have at least two functional groups “X”, which are covalently bound to the substructure, and where X is capable of coordinating to a metal or metalloid.

In some embodiments, each X is independently selected from neutral or ionic forms of CO₂H, OH, SH, NH₂, CN, HCO, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, and combination(s) thereof, where R is an alkyl group having from 1 to 5 carbon atoms, or an aryl group consisting of 1 to 2 phenyl rings.

In some embodiments, the organic ligand include substituted or unsubstituted, mono- or polynuclear aromatic di-, tri- and tetracarboxylic acids and substituted or unsubstituted, at least one hetero atom including aromatic di-, tri- and tetracarboxylic acids, which have one or more nuclei.

In some embodiments, the organic ligand is benzenetricarboxylate (BTC) (one or more isomers), ADC (acetylene dicarboxylate), NDC (naphtalenedicarboxylate) (any isomer), BDC (benzene dicarboxylate) (any isomer), ATC (adamantanetetracarboxylate) (any isomer), BTB (benzenetribenzoate) (any isomer), MTB (methane tetrabenzoate), ATB (adamantanetribenzoate) (any isomer), biphenyl-4,4′-dicarboxylate, benzene-1,3,5-tris(1H-tetrazole), imidazole, or derivatives thereof, or combination(s) thereof.

Ligands possessing multidentate functional groups may include corresponding counter cations, such as H⁺, Na⁺, K⁺, Mg²⁺, Ca²⁺, Sr⁺, ammonium ion, alkylsubstituted ammonium ions, and arylsubstituted ammonium ions, or counteranions, such as F⁻, Cl⁻, Br⁻, I⁻, ClO⁻, ClO₂_{^{−}}, ClO₃_{^{−}}, ClO₄_{^{−}}, OH⁻, NO₃_{^{−}}, NO₂_{^{−}}, SO₄²⁻, SO₃²⁻, PO₄³⁻, and CO₂²⁻.

In some embodiments, the organic ligands include monodentate functional groups. A monodentate functional group is defined as a moiety bound to a substructure, which may include an organic ligand or amine ligand substructure, L, as defined previously, which can form only one bond to a metal ion. According to this definition, a ligand may contain one or more monodentate functional groups. For example, cyclohexylamine and 4,4′-bipyridine are ligands that contain monodentate functional groups, since each functional group is capable of binding to only one metal ion.

Accordingly, cyclohexylamine is a monofunctional ligand containing a monodentate functional group and 4,4′-bipyridine is a difunctional ligand containing two monodentate functional groups. Specific examples of ligands containing monodentate functional groups are pyridine, which is a monofunctional ligand, hydroquinone, which is a difunctional ligand, and 1,3,5-tricyanobenzene, which is a trifunctional ligand.

Ligands having monodentate functional groups may be blended with ligands that contain multidentate functional groups to make MOF materials in the presence of a suitable metal ion and optionally a templating agent. Monodentate ligands may also be used as templating agents. Templating agents may be added to the reaction mixture for the purpose of occupying the pores in the resulting MOF materials. Monodentate ligands and/or templating agents may include may include the following substances and/or derivatives thereof:
A. alkyl or aryl amines or phosphines and their corresponding ammonium or phosphonium salts, the alkyl amines or phosphines may include linear, branched, or cyclic aliphatic groups, having from 1 to 20 carbon atoms (and their corresponding ammonium salts), the aryl amines or phosphines may include 1 to 5 aromatic rings including heterocycles. Examples of monofunctional amines are methylamine, ethylamine, n-propylamine, iso-propylamine, n-butylamine, sec-butylamine, iso-butylamine, tert-butylamine, n-pentylamine, neo-pentylamine, n-hexylamine, pyrrolidine, 3-pyrroline, piperidine, cyclohexylamine, morpholine, pyridine, pyrrole, aniline, quinoline, isoquinoline, 1-azaphenanthrene, and 8-azaphenanthrene. Examples of difunctional and trifunctional amines are 1,4-diaminocyclohexane, 1,4-diaminobenzene, 4,4′-bipyridyl, imidazole, pyrazine, 1,3,5-triaminocyclohexane, 1,3,5-triazine, and 1,3,5-triaminobenzene.
B. Alcohols that contain alkyl or cycloalkyl groups, containing from 1 to 20 carbon atoms, or aryl groups, containing from 1 to 5 phenyl rings. Examples of monofunctional alcohols are methanol, ethanol, n-propanol, iso-propanol, allyl alcohol, n-butanol, iso-butanol, sec-butanol, tert-butanol, n-pentanol, iso-pentanol, sec-pentanol, neo-pentanol, n-hexanol, cyclohexanol, phenol, benzyl alcohol, and 2-phenylethanol. Examples of difunctional and trifunctional alcohols are 1,4-dihydroxycyclohexane, hydroquinone, catechol, resorcinol, 1,3,5-trihydroxybenzene, and 1,3,5-trihydroxycyclohexane.
C. Ethers that contain alkyl or cycloalkyl groups, containing from 1 to 20 carbon atoms, or aryl groups, containing from 1 to 5 phenyl rings. Examples of ethers are diethyl ether, furan, and morpholine.
D. Thiols that contain alkyl or cycloalkyl groups, containing from 1 to 20 carbon atoms, or aryl groups, containing from 1 to 5 phenyl rings. Examples of monofunctional thiols are thiomethane, thioethane, thiopropane, thiocyclohexane, thiophene, benzothiophene, and thiobenzene. Examples of difunctional and trifunctional thiols are 1,4-dithiocyclohexane, 1,4-dithiobertzene, 1,3,5-trithiocyclohexane, and 1,3,5-trithiobenzene.
E. Nitriles that contain alkyl or cycloalkyl groups, containing from 1 to 20 carbon atoms, or aryl groups, containing from 1 to 5 phenyl rings. Examples of monofunctional nitriles are acetonitrile, propanenitrile, butanenitrile, n-valeronitrile, benzonitrile, and p-tolunitrile. Examples of difunctional and trifunctional nitriles are 1,4-dinitrilocyclohexane, 1,4-dinitrilobenzene, 1,3,5-trinitrilocyclohexane, and 1,3,5-trinitrilobenzene.
F. Inorganic anions from the group consisting of: sulfate, nitrate, nitrite, sulfite, bisulfite, phosphate, hydrogen phosphate, dihydrogen phosphate, diphosphate, triphosphate, phosphite, chloride, chlorate, bromide, bromate, iodide, iodate, carbonate, bicarbonate, thiocyanide and isonitrile, and the corresponding acids and salts of the aforementioned inorganic anions.
G. Organic acids and the corresponding anions (and salts). The organic acids may include alkyl organic acids containing linear, branched, or cyclic aliphatic groups, having from 1 to 20 carbon atoms, or aryl organic acids and their corresponding aryl organic anions and salts, having from 1 to 5 aromatic rings which may include heterocycles.
H. Other organic and inorganics such as ammonia, carbon dioxide, methane, oxygen, ethylene, hexane, benzene, toluene, xylene, chlorobenzene, nitrobenzene, naphthalene, thiophene, pyridine, acetone, 1-2-dichloroethane, methylenechloride, tetrahydrofuran, ethanolamine, triethylamine or trifluoromethylsulfonic acid.

Additionally, templating agents may include other aliphatic and aromatic hydrocarbons not containing functional groups. In some embodiments, templating agents include cycloalkanes, such as cyclohexane, adamantane, or norbornene, and/or aromatics, such as benzene, toluene, or xylenes.

### The Metal Ions

A MOF may be synthesized by combining metal ions, organic ligands, and optionally a suitable templating agent. Suitable metal ions include metals and metalloids of varying coordination geometries and oxidation states. In some embodiments, MOFs are produced using metal ions having distinctly different coordination geometries, in combination with a ligand possessing multidentate functional groups, and a suitable templating agent. MOFs may be prepared using a metal ion that prefers octahedral coordination, such as cobalt(II), and/or a metal ion that prefers tetrahedral coordination, such as zinc(II). MOF materials can be made using one or more of the following metal ions: Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, Be²⁺; along with the corresponding metal salt counterion. The term metal ion refers to both metal and metalloid ions. In some embodiments, metal ions suitable for use in production of MOF materials may include: Sc³⁺, Ti⁴⁺, V⁴⁺, V³⁺, V²⁺, Cr³⁺, Mo³⁺, Mg²⁺, Mn³⁺, Mn²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Al³⁺, Ga³⁺, In³⁺, Ge⁴⁺, Ge²⁺, Sn⁴⁺, Sn²⁺, Pb⁴⁺, Pb²⁺, Sb⁵⁺, Sb³⁺, Sb⁺, and/or Bi⁵⁺, Bi³⁺, Bi⁺, Be²⁺; along with the corresponding metal salt counteranion. In some embodiments, metal ions for use in production of MOF materials include: Sc³⁺, Ti⁴⁺, V⁴⁺, V³⁺, Cr³⁺, Mo³⁺, Mn³⁺, Mn²⁺, Fe³⁺, Fe²⁺, Co³⁺, Co²⁺, Ni²⁺, Ni⁺, Cu²⁺, Cu⁺, Ag⁺, Zn²⁺, Cd²⁺, Al³⁺, Sn⁴⁺, Sn²⁺, and/or Bi⁵⁺, Bi³⁺, Bi⁺; along with the corresponding metal salt counterion. In some embodiments, the metal ions for use in production of MOF materials are selected from the group consisting of: Mg²⁺, Mn³⁺, Mn²⁺, Fe³⁺, Fe²⁺, Co³⁺, Co²⁺, Ni²⁺, Ni⁺, Cu²⁺, Cu⁺, Pt²⁺, Ag⁺, Zn²⁺, along with the corresponding metal salt counterion.

### Production of MOF Materials

The synthesis of the rigid and stable MOF materials can be carried out under extremely mild reaction conditions. In most cases, the reagents are combined into a solution, either aqueous or nonaqueous, with synthetic reaction temperatures ranging from 0° C. to 100° C. (in an open beaker). In other cases, solution reactions are carried out in a closed vessel at temperatures from 25° C. to 300° C. In either case, large single crystals or microcrystalline microporous solids are formed.

In the preparation of the MOF materials, the reactants may be added in a mole ratio of 1:10 to 10:1 metal ion to ligand containing multidentate functional groups. In some embodiments, the metal ion to ligand containing multidentate functional groups is 1:3 to 3:1, such as from 1:2 to 2:1. The amount of templating agent may not affect the production of MOF materials, and in fact, templating agent can in some circumstances be employed as the solvent in which the reaction takes place. Templating agents can accordingly be employed in great excess without interfering with the reactions and the preparation of the MOF materials. Additionally, when using a ligand containing monodentate functional groups in combination with the metal ion and the ligand containing multidentate functional groups, the ligand containing monodentate functional groups may be utilized in excess. In certain circumstances the ligand containing monodentate functional groups can be utilized as the solvent in which the reaction takes place. In addition, in certain circumstances the templating agent and the ligand containing monodentate functional groups may be identical. An example of a templating agent which is a ligand containing monodentate functional groups is pyridine.

The preparation of the MOF materials may be carried out in either an aqueous or non-aqueous system. The solvent may be polar or nonpolar, and the solvent may be a templating agent, or the optional ligand containing a monodentate functional group. Examples of non-aqueous solvents include n-alkanes, such as pentane, hexane, benzene, toluene, xylene, chlorobenzene, nitrobenzene, cyanobenzene, aniline, naphthalene, naphthas, n-alcohols such as methanol, ethanol, n-propanol, isopropanol, acetone, 1,2,-dichloroethane, methylene chloride, chloroform, carbon tetrachloride, tetrahydrofuran, dimethylformamide, dimethylsulfoxide, thiophene, pyridine, ethanolamine, triethylamine, ethylenediamine, and the like. The appropriate solvent may be chosen based on solubility of the starting reactants, and the choice of solvent may not be critical in obtaining the MOF material.

To aid in the formation of large single crystals of microporous materials, suitable for single crystal x-ray structural characterization, the solution reaction may be performed in the presence of viscous materials, such as polymeric additives. Specific additives may include polyethylene oxide, polymethylmethacrylic acid, silica gels, agar, fats, and collagens, which may aid in achieving high yields and pure crystalline products. The growth of large single crystals of microporous materials leads to unambiguous characterization of the microporous framework. Large single crystals of microporous materials may be useful for magnetic and electronic sensing applications.

### Polymeric Binders

MOF extrudates include a MOF material and a polymeric binder (the binder including a polymer). In some embodiments, the polymeric binder includes an organic polymer. Polymeric binders may include additional additives, additional polymers, or exclude such additive or additional polymers. The polymeric binder may include any number of polymer types. Without intending to be bound by theory, it is thought that polymers containing polar side groups may bind well with MOF materials and produce an extrudate with superior mechanical strength.

The polymeric binder may include any suitable polymer, suitable polymers may include one or more of:
1. Biopolymers and derivatives thereof, such as various polysaccharides, starch, cellulose, or lignin. For example, a biopolymer can be a plant-based polymer. Plant based polymers include xanthan gum, scleroglucan, hydroxyethylated cellulose, carboxymethylcellulose, methylated cellulose, cellulose acetate, lignosulphonates, galactomannan, and derivatives thereof.
2. Polyolefins. Other useful polymers include polyethylene, isotactic polypropylene, highly isotactic polypropylene, syndiotactic polypropylene, random copolymer of propylene and/or ethylene, and/or butene, and/or hexene, LDPE, LLDPE, or HDPE ethylene-propylene rubber (EPR), vulcanized EPR, or ethylene propylene diene terpolymers (EPDM)
2. Polar polymers. Polar polymers include homopolymers and copolymers of esters, amides, acetates, anhydrides, copolymers of a C₂ to C₂₀ olefin, such as ethylene and/or propylene and/or butene with one or more polar monomers, such as acetates, anhydrides, esters, alcohol, and/or acrylics. Examples include polyesters, polyamides, ethylene vinyl acetate copolymers, polyvinyl chloride, polyvinyl alcohol, polyvinyl amine, or derivatives thereof.
3. Cationic polymers. Cationic polymers include polymers or copolymers of geminally disubstituted olefins, α-heteroatom olefins and/or styrenic monomers. Geminally disubstituted olefins include isobutylene, isopentene, isoheptene, isohexane, isooctene, isodecene, and isododecene. α-Heteroatom olefins include vinyl ether and vinyl carbazole. Styrenic monomers include styrene, alkyl styrene, para-alkyl styrene, α-methyl styrene, chloro-styrene, and bromo-para-methyl styrene. Examples of cationic polymers include butyl rubber, isobutylene copolymerized with para methyl styrene, polystyrene, and poly-α-methyl styrene.
4. Inorganic polymers. Inorganic polymers include such as polyphosphazenes and polysiloxanes.
5. Halogenated polymers: many of the aforementioned polymers may have a halogen substituted for hydrogen within the polymer forming halogenated polymers, such as nafion, polytetrafluoroethylene, or perfluoropolyether.

### Polysaccharide Polymers

In some embodiments, the polymeric binder includes biopolymer that is a polysaccharide polymer such as cellulose or starch. In some embodiments, the polymeric binder is a derivative of cellulose or starch, such as methylated, ethylated, or acetylated cellulose. In at least one embodiment, the polymeric binder includes hydroxypropyl methylcellulose, such as Methocel™ sold by Dupont Specialty Solutions.

### Polyvinyl Amine and Polyvinyl Amide Polymers

In some embodiments, the polymeric binder includes a polyvinyl amide or a polyvinyl amine such as poly(N-vinyl acetamide), poly(N-vinyl formamide), poly(N-vinyl isobutyramide), poly(vinylamine), or poly(N-vinyl pyrrolidone). In some embodiments, the polymeric binder is a derivative of a polyvinyl amide or a polyvinyl amine. In at least one embodiment, the polymeric binder includes polyvinylpyrrolidone (PVP). In at least one embodiments, the polymeric binder includes poly(allylamine).

### Polyvinyl Alcohol and Derivatives

In some embodiments, the polymeric binder includes a polyvinyl alcohol or a derivative, such as polyvinyl alcohol, polyvinyl acetate, polyvinyl butyrate, or polyvinyl propionate. In at least one embodiment, the polymeric binder includes polyvinyl alcohol (PVA). In at least one embodiments, the polymeric binder includes polyvinyl acetate or polyvinyl butyrate.

### Polyamides

In some embodiments, the polymeric binder is a polyamide, such as an aliphatic polyamide or an aromatic polyamide. In some embodiments, the polyamide is polycaprolactam, poly(hexamethyleneadipamide), polyphthalamide, or an aramide, such as poly paraphenylene terephthalamide.

### Polyesters

In some embodiments, the polymeric binder is a polyester, such as an aliphatic polyester or an aromatic polyester. In some embodiments, the polyester is polylactic acid, polycaprolactone, polyhydroxybutyrate, polyethylene adipate, polyethylene terephthalate, polybutylene terephthalate, or poly paraphenylene terephthalate.

### Polyethers

In some embodiments, the polymeric binder is a polyether, such as an aliphatic polyether or an aromatic polyether. In some embodiments, the polyether is polyethylene glycol, polypropylene glycol, polytetrahydrofuran, polydioxanone, paraformaldehyde, or poly(p-phenylene oxide.

### Polyacrylates and Polycarbonates

In some embodiments, the polymeric binder is a polyacrylate or a polycarbonate, such as poly(acrylic acid), poly (methyl methacrylate), poly(benzyl acrylate, poly(ethyl acrylate), poly(butyl methacrylate), or polycarbonate of bisphenol A.

### Halogenated Polymers

In some embodiments, the polymeric binder is a halogenated polymer, such as a perfluorinated polymer. Perfluorinated polymers may include sulfonated poly(tetrafluoroethylene), sulfonated poly(tetrafluoroethyleneoxide), poly(perfluoromethylvinlyether), poly(perfluoropropylvinlyether), poly(perfluoropropylene), or perfluoropolyether.

### Polymer Blends

In some embodiments, the polymer of the polymeric binder is a blend of a plurality of polymers, such as a first polymer is present in a blend, at from 10 wt % to 99 wt %, based upon the total weight of the polymers in the blend, such as 20 wt % to 95 wt %, 30 wt % to 90 wt %, 40 wt % to 90 wt %, 50 wt % to 90 wt %, 60 wt % to 90 wt %, or 70 wt % to 90 wt %. A second polymer is present in a blend, at from 10 wt % to 99 wt %, based upon the total weight of the polymers in the blend, such as 20 wt % to 95 wt %, 30 wt % to 90 wt %, 40 wt % to 90 wt %, 50 wt % to 90 wt %, 60 wt % to 90 wt %, or 70 wt % to 90 wt %.

Blends may be produced by mixing the polymers of the present disclosure with one or more polymers (as described above), by connecting reactors together in series to make reactor blends or by using more than one catalyst in the same reactor to produce multiple species of polymer. The polymers can be mixed together prior to being put into the extruder or may be mixed in an extruder prior to being mixed with the MOF material.

The blends may be formed using any suitable equipment and methods, such as by dry blending the individual components and subsequently melt mixing in a mixer, or by mixing the components together directly in a mixer, such as, for example, a Banbury mixer, a Haake mixer, a Brabender internal mixer, or a single or twin-screw extruder, which may include a compounding extruder and a side-arm extruder used directly downstream of a polymerization process, which may include blending powders or pellets of the resins at the hopper of the film extruder.

### Optional Binder Additives

Additionally, additives may be included in the binder, as desired. Such additives may include, for example: fillers; antioxidants (e.g., hindered phenolics such as IRGANOX™ 1010 or IRGANOX™ 1076 available from Ciba-Geigy); phosphites (e.g., IRGAFOS™ 168 available from Ciba-Geigy); anti-cling additives; tackifiers, such as polybutenes, terpene resins, aliphatic and aromatic hydrocarbon resins, alkali metal and glycerol stearates, and hydrogenated rosins; UV stabilizers; heat stabilizers; anti-blocking agents; release agents; anti-static agents; pigments; colorants; dyes; waxes; silica; fillers; talc.

The binder may also optionally include silica, such as precipitated silica and silica originating from by-products such as fly-ash, for example silica-alumina, silica-calcium particles, or fumed silica. In some embodiments, the silica is particulate matter and has an average particle size of 10 μm or less, such as 5 μm or less, or 1 μm or less. In some embodiments the silica is amorphous silica

Additional additive may be included, such as inorganic compounds, such as titanium dioxide, hydrated titanium dioxide, hydrated alumina or alumina derivatives, mixtures of silicon and aluminum compounds, silicon compounds, clay minerals, alkoxysilanes, and amphiphilic substances.

Other additives may include any suitable compound use for adhesion of powdery materials, such as oxides, of silicon, of aluminum, of boron, of phosphorus, of zirconium and/or of titanium. Additionally, additives may include oxides of magnesium and of beryllium and clays, for example montmorillonites, kaolins, bentonites, halloysites, dickites, nacrites and anauxites. Furthermore, tetraalkoxysilanes may be used as additives to the polymeric binder, such as tetramethoxysilane, tetraethoxysilane, tetrapropoxysilane and tetrabutoxysilane, the analogous tetraalkoxytitanium and tetraalkoxyzirconium compounds and trimethoxy-, triethoxy-, tripropoxy- and tributoxy-aluminum.

The additive may have a concentration of from 0 wt % to 20 wt % based on the total weight of the polymeric binder.

Production of MOF Extrudate with Higher Crush Strength

The present disclosure also relates to processes for the preparation of MOF extrudates, granules, or shaped-bodies. A process may include mixing a MOF material with a polymeric binder (with optional additives), and an optional solvent to form a mixture. An alternative process may include preparing a polymeric binder in the presence of a MOF material, such as including a MOF material in a polymerization reactor/reaction to form a mixture. The processes also include extruding the mixture forming an extrudate, forming the mixture into shaped-bodies, or granulating the mixture. In some embodiments, the mixture is extruded to form an extrudate, which can be shaped or granulated to form granules or shaped-bodies. The process may also include washing the extrudate with a solvent. A process may also include drying and/or calcining the extrudate.

A solvent may be selected from any suitable solvent for mixing MOF materials with a binder, such as water, alcohols, ketones, amides, esters, ethers, nitriles, aromatic hydrocarbons, aliphatic hydrocarbons, and combination(s) thereof. In some embodiments, the solvent is selected from the group consisting of water, methanol, ethanol, dimethylformamide, acetone, diethylether, acetonitrile, and combination(s) thereof. In some embodiments, the solvent is water. In some embodiments, the solvent is a mixture of two or more solvents. In some embodiments, there is no solvent. The same solvents may be used to wash the composition during various stages of the process, including washing the extrudate, granules, or shaped-bodies.

Mixing may be accomplished in any suitable manner including, such as by dry blending the individual components and subsequently melt mixing in a mixer, or by mixing the components together directly in a mixer, such as, for example, a Banbury mixer, a Haake mixer, a Brabender internal mixer, high shear mixer, drum mixer, or a single or twin-screw extruder, which may include a compounding extruder and a side-arm extruder used directly downstream of a polymerization process, which may include blending powders or pellets of the MOF material and polymeric binder at the hopper of the extruder. In some embodiments, the mixing and extruding are simultaneous, such as when the MOF material and the polymeric binder are mixed in an extruder and extruded. In alternative embodiments, the MOF material and polymeric binder are mixed with an optional solvent before extrusion.

In some embodiments, the MOF material and the polymeric binder are premixed as dry materials before addition of a solvent. In some embodiments, the dry material mixture is extruded without the use of a solvent. In another embodiment, the polymeric binder may be in solution or in suspension in a solvent before the addition of the MOF material to the suspension or solution, which is then mixed. The order of addition of the components (MOF material, polymeric binder, optional solvent) is not critical. It is possible either to add the polymeric binder, the MOF material, and optional solvent in any order, the most suitable order is determined by the type of mixers employed.

Mixing may be accomplished by methods of materials processing and unit operations. If the mixing occurs in the liquid phase, stirring may be use, if the mass to be mixed is paste-like, kneading and/or extruding may be used and if the components to be mixed are all in a solid, powdery state, mixers may be used. The use of atomizers, sprayers, diffusers or nebulizers is conceivable as well, if the state of the components to be used allows the use thereof. For MOF materials that are paste-like or powder-like the use of static mixers, planetary mixers, mixers with rotating containers, pan mixers, pug mills, shearing-disk mixers, centrifugal mixers, sand mills, trough kneaders, internal mixers, internal mixers and continuous kneaders may be desired. A mixing process of mixing may also be sufficient to achieve the molding or extruding, such as when mixing and extruding coincide.

The mixing may take place in a continuous fashion or in batches. In the case where mixing is carried out in a batch, it may be carried out in a mixer equipped with Z arms, or with cams, or in another type of mixer, such as a planetary mixer. The mixing may provide a homogenous mixture of the pulverulent constituents.

Mixing may take place for a duration of 5 to 60 min, such as 10 to 50 min The speed of rotation of the mixer arms may be 10 to 75 rpm, such as 25 to 50 rpm.

The mixture may include from 1 wt % to 99 wt %, such as from 5 wt % to 99 wt %, from 7 wt % to 99 wt %, or from 10 wt % to 95 wt % of the MOF material; from 1 wt % to 99 wt %, such as from 1 wt % to 90 wt %, from 1 wt % to 50 wt %, or from 1 wt % to 20 wt % of the polymeric binder (including optional additives), and optionally from 0 wt % to 20 wt %, such as from 1 wt % to 15 wt %, from 1 wt % to 10 wt %, or from 1 wt % to 7 wt % of solvent. The percentages by weight being expressed with respect to the total quantity of compounds and/or powders in the mixture and the sum of the quantities of each of the compounds and the powders in the mixture being equal to 100%. In some embodiments, the mixture includes from about 20 wt % to about 70 wt % solids, based on the total weight of the mixture.

The mixture is then (or simultaneously) extruded. The extrusion may take place in a single or twin-screw ram extruder. In the case where a process of preparation is carried out continuously, the mixing may be couple with extrusion in one or more pieces of equipment. According to this implementation, the extrusion of the mixture, also called “kneaded paste”, may be carried out either by extruding directly at the end of a continuous mixer of the twin-screw type for example, or by connecting one or more batch mixers to an extruder. The geometry of the die, which gives the extrudates their shape, may be selected from any suitable die, such as cylindrical, multilobed, grooved shape, or slitted.

In an embodiment, the shaping of the metal-organic framework material occurs at pressures greater than about 300 psig.

The extrusion may be affected by the quantity of solvent added in the mixing and may be adjusted to obtain a mixture or a paste that does not flow and is not overly dry, so as to allow its extrusion under suitable conditions of pressure dependent on the extrusion equipment used. In some embodiments, the extrusion is carried out at an extrusion pressure of about 1 MPa or more, such as from about 1 MPa to about 20 MPa, from about 2 MPa to about 15 MPa, or from about 3 MPa to about 10 MPa.

The extrudate may include be pelletized and the product be in the form of extrudate or pellets. However, it is not excluded that the materials obtained are then, for example, introduced into equipment for rounding their surface, such as a tumbler or any other equipment for spheronization.

The extrudates may have a diameter of from about 1 to about 10 mm, such as from about 1.5 to about 5 mm. In some embodiments, the mixture is extruded through a dye with a diameter of from about 0.01 mm to about 50 mm, such as from about 0.05 mm to about 40 mm, from about 0.1 mm to about 20 mm, from about 0.2 mm to about 10 mm, or from about 0.5 mm to about 7 mm. Such extrusion apparatuses are described, for example, in Ullmann's Enzylopädie der Technischen Chemie, 4th Edition, Vol. 2, p. 295 et seq., 1972. In addition to the use of an extruder, an extrusion press may also be used.

A process for the preparation of MOF extrudates may also optionally include maturation, such as drying or setting the extrudate. The maturation may include temperatures of about 0° C. to about 300° C., such as about 20° C. to about 200° C., or about 20° C. to about 150° C. The maturation may take place for a duration of about 1 min to about 72 h, such as about 30 min to about 72 h, about 1 h to about 48 h, or about 1 h to about 24 h. In some embodiments, the maturation may be carried out in air or humidified air with a relative humidity of 20% to 100%, such as 70% to 100%. The treatment with humidified gas may allow for hydration of the material, which may be beneficial to setting certain polymeric binders. In some embodiments, the maturation is carried out in air or inert gas that is dehumidified, such as air with a relative humidity of 0% to 10%, or of 0% to 5%. The humidity of the drying gas will be related to the choice of polymeric binder, for example a hydrophilic polymeric binder may be subject to maturation under greater humidity to provide a more pliable MOF extrudate, and conversely the same hydrophilic polymeric binder may be subject maturation under low humidity to provide a stiffer MOF extrudate.

The extrudate or matured extrudate may also optionally undergo calcination. Calcination may take place at temperatures of about 50° C. to about 500° C., such as about 100° C. to about 300° C. Calcination may take place for a duration of about 1 h to about 6 h, such as about 1 h to about 4 h. Calcination may aid in removal of solvent used for facilitating the extruding of the mixture. The calcination may take place in air, inert gas, or a mixture containing oxygen. Additionally, calcination may take place at reduced or increased pressure, such as in vacuo or pressures greater than atmospheric pressure. In some embodiments, the extrudates are calcined under dry air or air with different levels of humidity or they are heat-treated in the presence of a gas mixture including an inert gas, such as nitrogen and/or oxygen. In some embodiments, the gas mixture used may include 5 vol % or more, such as 10 vol % or more oxygen. In alternative embodiments, the gas mixture is free of or substantially free of oxygen and include only inert gases.

The calcination temperature may be from about 50° C. to about the degradation temperature of the MOF material, however the addition of polymeric binders may improve (increase) the temperature of degradation of the MOF material, so the calcination temperature may include temperatures above the degradation temperature of the MOF material alone.

### Properties of MOF Extrudates

MOF extrudates of the present disclosure may have a bulk crush strength of from about 0.2 lb-force to about 80 lb-force, such as about 0.4 lb-force to about 50 lb-force, from about 1 lb-force to about 20 lb-force, or from about 4 lb-force to about 15 lb-force. The crush strength may be related to the extrudate size and extrudates may have a shaped body that extends to about 1 mm or more in each direction in space. The bulk crush strength is a standardized test (ASTM D7084-04).

A remarkably high surface area per volume is found for an extrudate containing a MOF material in a selected range of hardness, where the shaped body has a bulk crush strength from about 0.2 lb-force to about 80 lb-force. In some embodiments, the crush strength is from about 4 lb-force to about 15 lb-force.

A MOF extrudate may have a BET surface area (measured using ASTM D3663) of about 50 m²/g to about 4,000 m²/g, about 50 m²/g to about 3,000 m²/g, about 50 m²/g to about 2,000 m²/g, about 100 m²/g to about 1,800 m²/g, about 100 m²/g to about 1,700 m²/g, about 100 m²/g to about 1,600 m²/g, about 100 m²/g to about 1,550 m²/g, about 100 m²/g to about 1,500 m²/g, about 100 m²/g to about 1,450 m²/g, about 100 m²/g to about 1,400 m²/g, about 100 m²/g to about 1,300 m²/g, about 100 m²/g to about 1,250 m²/g, about 100 m²/g to about 1,200 m²/g, about 100 m²/g to about 1,150 m²/g, about 100 m²/g to about 1,100 m²/g, about 100 m²/g to about 1,050 m²/g, about 100 m²/g to about 1,000 m²/g, about 100 m²/g to about 900 m²/g, about 100 m²/g to about 850 m²/g, about 100 m²/g to about 800 m²/g, about 100 m²/g to about 700 m²/g, about 100 m²/g to about 600 m²/g, about 100 m²/g to about 550 m²/g, about 100 m²/g to about 500 m²/g, about 100 m²/g to about 450 m²/g, about 100 m²/g to about 400 m²/g, about 100 m²/g to about 300 m²/g, about 100 m²/g to about 200 m²/g, about 300 m²/g to about 1,800 m²/g, about 300 m²/g to about 1,700 m²/g, about 300 m²/g to about 1,600 m²/g, about 300 m²/g to about 1,550 m²/g, about 300 m²/g to about 1,500 m²/g, about 300 m²/g to about 1,450 m²/g, about 300 m²/g to about 1,400 m²/g, about 300 m²/g to about 1,300 m²/g, about 300 m²/g to about 1,250 m²/g, about 300 m²/g to about 1,200 m²/g, about 300 m²/g to about 1,150 m²/g, about 300 m²/g to about 1,100 m²/g, about 300 m²/g to about 1,050 m²/g, about 300 m²/g to about 1,000 m²/g, about 300 m²/g to about 900 m²/g, about 300 m²/g to about 850 m²/g, about 300 m²/g to about 800 m²/g, about 300 m²/g to about 700 m²/g, about 300 m²/g to about 600 m²/g, about 300 m²/g to about 550 m²/g, about 300 m²/g to about 500 m²/g, about 300 m²/g to about 450 m²/g, or about 300 m²/g to about 400 m²/g. In particular, the MOF extrudate may have a total BET surface area of about 300 m²/g to about 4,000 m²/g, such as from about 500 m²/g to about 1,600 m²/g.

Additionally, the MOF extrudate may have a comparative BET surface area of about 30% to about 100%, such as from about 50% to about 95%, or from about 70% to about 90% (measured using ASTM D3663) of the pristine MOF. A comparative BET surface area is defined as the BET surface area of the MOF extrudate divided by the BET surface area of the MOF material. For example, if a MOF extrudate is prepared using HKUST-1 and the extrudate has a BET surface area of 1292 m²/g, then the MOF extrudate would have an 80% comparative BET surface area because 1292 m²/g is 80% of 1615 m²/g (the calculated BET surface area of HKUST-1).

A MOF extrudate may have a pore volume (measured using ASTM D3663) of about 0 cm³/g to about 1.6 cm³/g, about 0.2 cm²/g to about 1.6 cm³/g, about 0.2 cm²/g to about 1.5 cm³/g, about 0.2 cm³/g to about 1.4 cm³/g, about 0.2 cm³/g to about 1.3 cm³/g, about 0.3 cm³/g to about 1.2 cm³/g, about 0.3 cm³/g to about 1.1 cm³/g, about 0.4 cm³/g to about 1.1 cm³/g, or about 0.4 cm³/g to about 1 cm³/g. A MOF extrudate may have a porosity of about 30% to about 100%, such as from about 50% to about 95%, or from about 70% to about 90% (measured using ASTM D3663) of the pristine MOF material.

A MOF extrudate may have an average pore diameter size of about 1 Å to about 40 Å, such as from about 2 Å to about 25 Å, or from about 6 Å to about 23 Å (measured using ASTM D4365).

### Applications

The MOF extrudate may be used for applications in catalysis, separation, purification, capture, etc. For example, the MOF extrudate may be brought into contact with the gaseous feedstock to be treated in a reactor, which may be either a fixed-bed reactor, or a radial reactor, or a fluidized-bed reactor. In the case of an application in the areas of catalysis and separation, the expected value of ACS is greater than 0.9 daN/mm, such as greater than 1 daN/mm. Therefore, the MOF extrudates described have sufficient mechanical strength to be used in areas of catalysis and separation.

The MOF extrudates may be used in processes where a porous body or a body with channels provides an advantage over solid bodies or powders. In particular, such applications include: catalysts, support for catalysts, sorption, storage of fluids, desiccants, ion exchanger materials, molecular sieves (separators), materials for chromatography, materials for the selective release and/or uptaking of molecules, molecular recognition, nanotubes, nano-reactors.

In some embodiments of applications, the MOF extrudates are used as catalysts in fixed bed/packed bed reactors. In principle, the MOF extrudates may be used in gas phase reactions or in liquid phase reactions, in which case the solid shaped bodies are suspended in a slurry. Additionally, the MOF extrudates may be used to catalyze various reactions where the presence of channels and/or pores incorporated therein are known or believed to increase the activity and/or selectivity and/or yield of the reaction.

Another application is the storage of compounds, especially of gaseous compounds. The pore size and porosity of the MOF extrudate may allow for excellent storage or sequestration of gaseous compounds, such as CO₂, CH₄, or H₂, all of which are of particular interest in the energy industry.

### Embodiments of the Present Disclosure

Clause 1. A composition including:
a metal-organic framework material; and
a polymeric binder;
the material having a bulk crush strength of about 6 2.5 lb-force or greater.

Clause 2. The composition of clause 1, where the composition is an extrudate, granule, or a shaped body.

Clause 3. The composition of any of clauses 1 to 2, where the composition has a bulk crush strength of about 6 lb-force or greater.

Clause 4. The composition of any of clauses 1 to 3, where the metal-organic framework material includes an organic ligand including one or more of:
an alkyl group substructure having from 1 to 10 carbon atoms; or
an aryl group substructure having from 1 to 5 aromatic rings; and
where the one or more substructures each have at least two X groups, and where X is a functional group configured to coordinate to a metal or metalloid.

Clause 5. The composition of clause 4, where the metal-organic framework material includes an organic ligand including an alkylamine substructure having from 1 to 10 carbon atoms or an arylamine or nitrogen-containing heterocycle substructure having from 1 to 5 aromatic rings; and where the substructure(s) each have at least two X groups, and where X is a functional group configured to coordinate to a metal or metalloid.

Clause 6. The composition of clause 4, where each X is independently selected from the group consisting of neutral or ionic forms of OH, SH, CO₂H, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen containing heterocycles, and combination(s) thereof, where R is an alkyl group having from 1 to 5 carbon atoms or an aryl group consisting of 1 to 2 phenyl rings.

Clause 7. The composition of clause 6, where the organic ligand is selected from the group consisting of 1,3,5-benzenetricarboxylate, 1,4-benzenedicarboxylate, 1,3-benzenedicarboxylate, biphenyl-4,4′-dicarboxylate, benzene-1,3,5-tris(1H-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, and combination(s) thereof.

Clause 8. The composition of any of clauses 1 to 7, where the metal-organic framework material includes a metal ion selected from the group consisting of Be²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, and combination(s) thereof.

Clause 9. The composition of clause 8, where the metal ion is selected from the group consisting of Mg²⁺, Mn³⁺, Mn²⁺, Fe³⁺, Fe²⁺, Co³⁺, Co²⁺, Ni²⁺, Ni⁺, Cu²⁺, Cu⁺, Pt²⁺, Ag⁺, Zn²⁺, Cd²⁺, and combination(s) thereof.

Clause 10. The composition of any of clauses 1 to 9, where the metal-organic framework material is selected from the group consisting of HKUST-1, UiO-66, ZIF-8, ZIF-7, MIL-100, MOF-74, MOF-274, and combination(s) thereof.

Clause 11. The composition of any of clauses 1 to 10, where the polymeric binder includes a biopolymer or a derivative thereof.

Clause 12. The composition of clause 11, where the biopolymer is selected from the group consisting of xanthan gum, scleroglucan, hydroxyethylated cellulose, carboxymethylcellulose, methylated cellulose, hydroxypropylated cellulose, cellulose acetate, lignosulphonates, galactomannan, cellulose ethers, derivatives thereof, and combination(s) thereof.

Clause 13. The composition of any of clauses 1 to 12, where the polymeric binder includes a polyolefin.

Clause 14. The composition of clause 13, where the polyolefin is selected from the group consisting of a polyethylene, a polypropylene, an ethylene propylene diene terpolymer, and a random copolymer of at least one of propylene and ethylene and one or more of butene and/or hexene.

Clause 15. The composition of any of clauses 1 to 14, where the polymeric binder includes a polar polymer.

Clause 16. The composition of clause 15, where the polar polymer is a polyvinyl amide, a polyvinyl amine, or combination(s) thereof.

Clause 17. The composition of clause 15, where the polar polymer is a polyvinyl alcohol, a polyvinyl ester, or combination(s) thereof.

Clause 18. The composition of clause 15, where the polar polymer is selected from the group consisting of a polyamide, a polyester, a polyether, and combination(s) thereof.

Clause 19. The composition of clause 15, where the polar polymer is a polyacrylate, a polycarbonate, or combination(s) thereof.

Clause 20. The composition of any of clauses 1 to 19, where the polymeric binder includes a styrenic polymer.

Clause 21. The composition of any of clauses 1 to 20, where the polymeric binder includes a polysiloxane.

Clause 22. The composition of any of clauses 1 to 21, where the polymeric binder includes a halogenated polymer.

Clause 23. The composition of any of clauses 1 to 22, wherein the composition has a comparative BET surface area of about 70% to about 100%.

Clause 24. The composition of any of clauses 1 to 23, wherein the composition has a porosity of from about 70% to about 100% of the metal-organic framework material.

Clause 25. The composition of any of clauses 1 to 24, wherein the composition has a pore size of about 2 Å to about 25 Å.

Clause 26. A process for producing a metal-organic framework extrudate, the process including:
mixing a metal-organic framework material, a polymeric binder, and optionally a solvent to form a mixture; and
extruding the mixture to form a metal-organic framework extrudate.

Clause 27. The process of clause 26, further including maturing the metal-organic framework extrudate at a temperature of about 20° C. to about 100° C. for a period of about 30 minutes or greater.

Clause 28. The process of any of clauses 26 to 27, further including calcining the metal-organic framework extrudate at a temperature of about 100° C. to about 300° C. for a period of about 1 hour or greater.

Clause 29. The process of any of clauses 26 to 28, wherein the extruding the mixture is performed through a dye with a diameter of about 0.5 mm to about 7 mm.

Clause 30. The process of any of clauses 26 to 29, wherein the mixture comprises from about 20 wt % to about 70 wt % solids, based on the total weight of the mixture.

Clause 31. The process of any of clauses 26 to 30, wherein the solvent is selected from the group consisting of water, alcohols, ketones, amides, esters, ethers, nitriles, aromatic hydrocarbons, aliphatic hydrocarbons, and combination(s) thereof.

Clause 32. The process of any of clauses 26 to 31, wherein the solvent is selected from the group consisting of water, methanol, ethanol, dimethylformamide, acetone, diethylether, acetonitrile, and combination(s) thereof.

Clause 33. The process of any of clauses 26 to 32, further comprising washing the metal-organic framework extrudate with a solvent.

### EXAMPLES

### General

In a typical extrusion experiment, a metal-organic framework, a binder (0-35 wt %), and water (40-60 wt %) are mixed together using a mortar and pestle for 5 min. The binder can be pre-dissolved in the water or mixed as a powder. The amount of water used in the mull mix depends on the identity of the MOF and binder, and can be determined for a given material. The mull mix is then extruded through a 1/16″ cylindrical dye on a hand press. The extrudates are air dried for four hours before being placed in a 120° C. oven for 16-20 h. The crushing strength of the resultant extrudates is measured using the ASTM D7084 method on a Varian VK200.

Extrusions with Methyl-Cellulose Based Binders

Table 1 provides relevant trials for a variety of MOF materials using the hydroxypropyl methylcellulose-based binder, Methocel, along with comparative samples (either self-bound or with an Al₂O₃ binder: Versal-300). The table includes data related to crush strength and surface area. The MOFs prepared with polymeric binders show improved crush strength without significant loss in surface area.

TABLE 1
Crush Strength and Surface Area of MOFs

| | | | | | Surface |
|---|---|---|---|---|---|
| | | | Binder | Crush | Area |
| | | | Amount | Strength | Retention |
| MOF | Comparative | Binder | (wt %) | (lb-force) | (%) |
| UiO-66 | Comparative | Self | 0 | 0 | — |
| UiO-66 | Comparative | Versal-300 | 35 | 0 | 105 |
| UiO-66 | | Methocel | 10 | 8.6 | 107 |
| UiO-66 | | Methocel | 20 | 14 | 91 |
| ZIF-8 | Comparative | Self | 0 | 0 | 88.3 |
| ZIF-8 | Comparative | Versal-300 | 35 | 1.6 | 102 |
| ZIF-8 | | Methocel | 10 | 9.4 | 86.2 |
| ZIF-7 | Comparative | Self | 0 | 0 | — |
| ZIF-7 | Comparative | Versal-300 | 35 | 0 | 83.9 |
| ZIF-7 | | Methocel | 10 | 5.9 | 71.2 |
| HKUST-1 | Comparative | Self | 0 | 0 | 1.48 |
| HKUST-1 | | Methocel | 10 | 14 | 46.7 |
| HKUST-1 | | Methocel | 20 | 14 | 44.5 |
| MIL- | Comparative | Self | 0 | 0 | 62.3 |
| 100(Fe) | | | | | |
| MIL- | Comparative | Versal-300 | 35 | 0 | — |
| 100(Fe) | | | | | |
| MIL- | | Methocel | 10 | 11 | 85 |
| 100(Fe) | | | | | |
| MIL- | | Methocel | 20 | 21 | — |
| 100(Fe) | | | | | |
| MOF- | Comparative | Self | 0 | 0 | — |
| 74(Mg) | | | | | |
| MOF- | Comparative | Methocel | 10 | 7.3 | — |
| 74(Mg) | | | | | |
| MOF- | | Cellulose | 10 | 0 | — |
| 74(Mg) | | Acetate | | | |
| MOF- | | Chitosan | 10 | 0 | — |
| 74(Mg) | | | | | |

For many applications, a crushing strength of 6 lb-force or greater is a typical specification to meet standards for handling of an extrudate. MOFs when extruded with Methocel meet this specification. In analogous examples where no binder is included, the MOF extrudates lack significant mechanical strength. Additionally, extrudates with a large percentage of the alumina-based Versal-300 binder also have poor mechanical strength. In most cases, increasing the Methocel content improves the mechanical strength further.

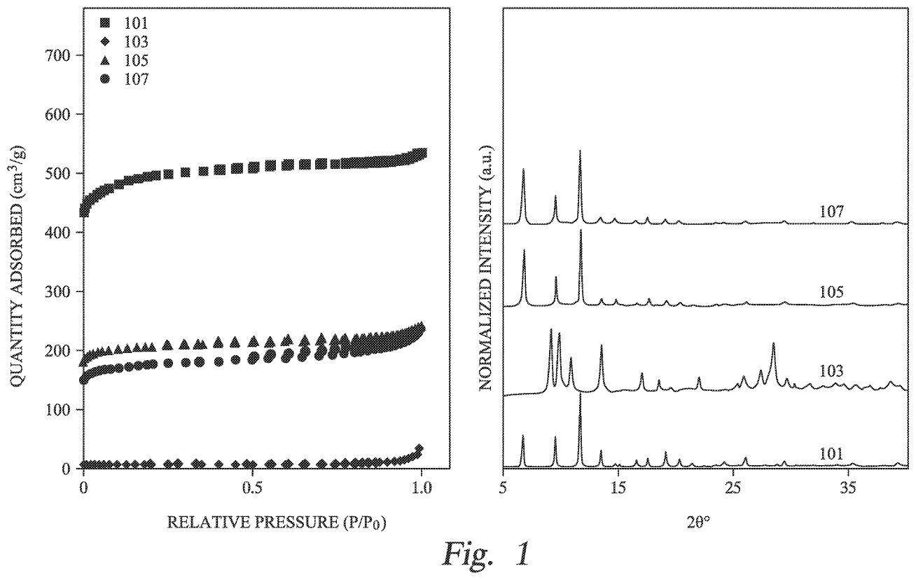

Referring now to FIG. 1 a representation of adsorption and x-ray diffraction data of HKUST-1 in bound and unbound forms with various binders. HKUST-1 is a MOF including copper and 1,3,5-benzenetricarboxylic acid. 101 represents HKUST-1 crystalline powder, not bound, extruded, or shaped. 103 represents HKUST-1 in a self-bound form. 105 represent HKUST-1 bound with 10 wt % Methocel. 107 represents HKUST-1 bound with 20 wt % Methocel. The PXRD patterns demonstrate that binding with Methocel does not affect the crystalline structure of the HKUST-1, whereas HKUST-1 decomposes upon extrusion when self-bound in water. The HKUST-1 that is bound with Methocel has a lower N₂ adsorption at a similar surface area (refer back to Table 1).

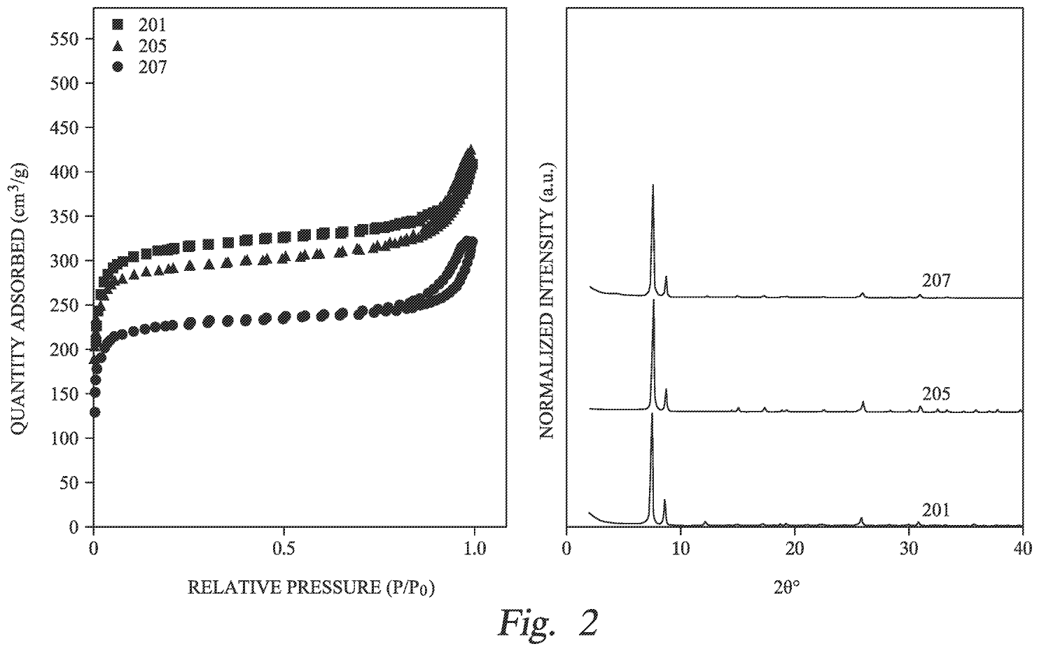

Referring now to FIG. 2, a representation of adsorption and x-ray diffraction data of water-stable UiO-66 in bound and unbound forms with various binders. UiO-66 is a MOF including Zr₆O₄(OH)₄ and 1,4-benzenedicarboxylic acid. 201 represents UiO-66 in a crystalline powder not bound, extruded, or shaped 205 represents UiO-66 bound with 10 wt % Methocel. 207 represents UiO-66 bound with 20 wt % Methocel. While, the adsorption of N₂ decreases with increasing Methocel, the adsorption is still relatively similar to the crystalline powder form of UiO-66.

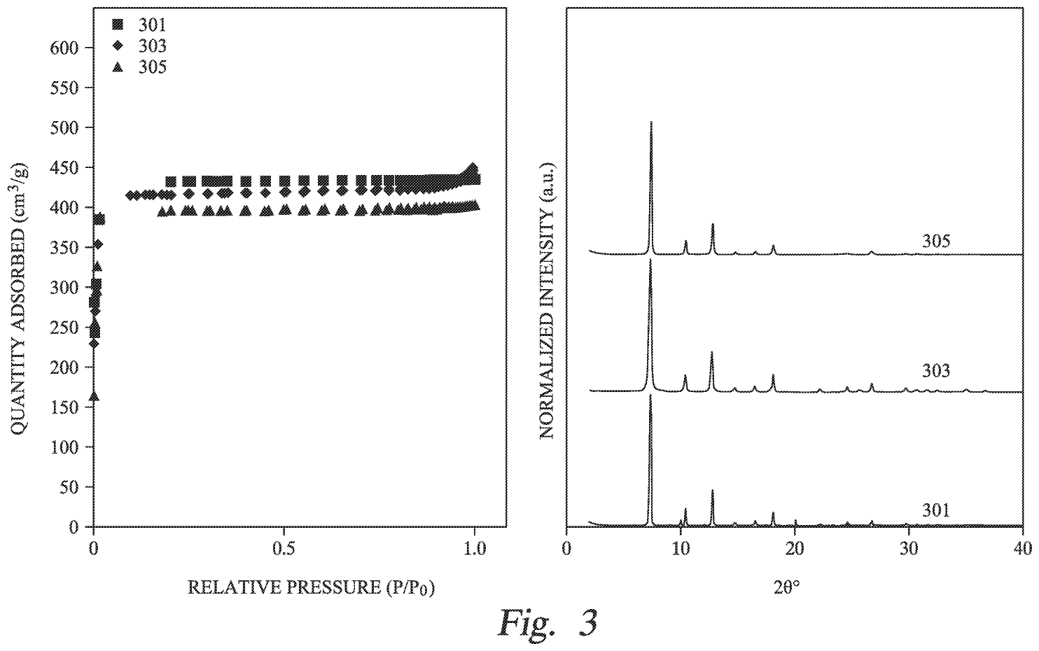

Referring now to FIG. 3, a representation of adsorption and x-ray diffraction data of ZIF-8 in bound and unbound forms with various binders. ZIF-8 is a MOF including zinc and imidazole. 301 represents ZIF-8 in a crystalline powder not bound, extruded, or shaped. 303 represents ZIF-8 in a self-bound form. 305 represents ZIF-8 with 10 wt % Methocel. There is very little difference in adsorption or the PXRD spectra of the bound and unbound ZIF-8, but referring back to table 1, there is a large difference in the crush strength (9.4 lb-force).

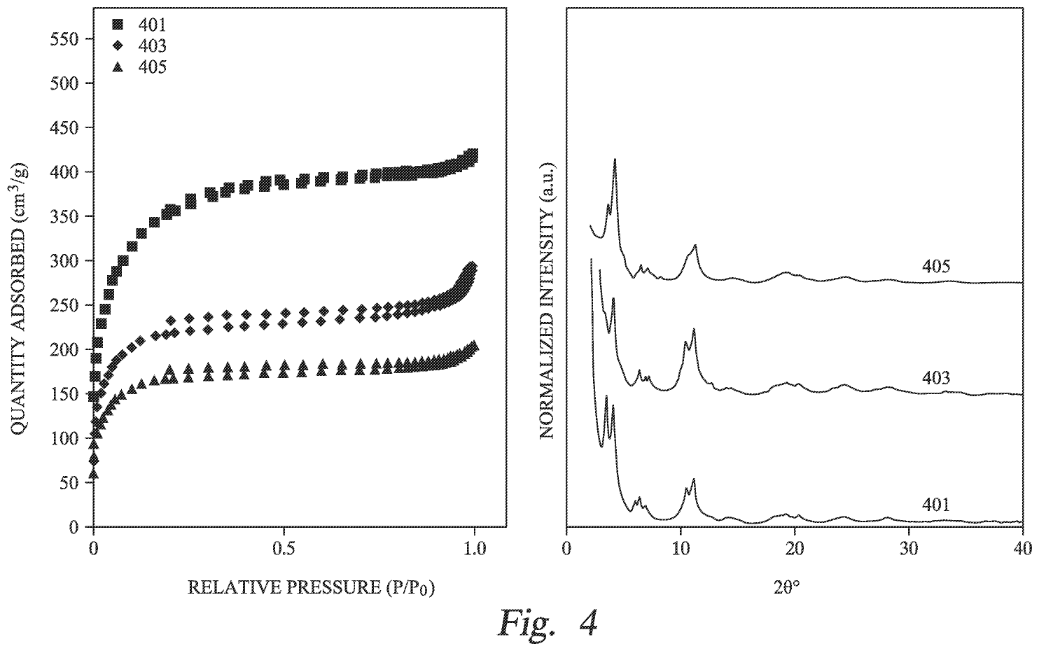

Referring now to FIG. 4, a representation of adsorption and x-ray diffraction data of MIL-100in bound and unbound forms with various binders. MIL-100is a MOF including a trivalent cation, including, for example, iron or chromium and 1,3,5-benzenetricarboxylic acid. 401 represents MIL-100(Fe) in a crystalline powder not bound, extruded, or shaped. 403 represents MIL-100(Fe) in a self-bound form. 405 represents MIL-100(Fe) with 10 wt % Methocel. There is a decrease in N₂ absorbance from the crystalline powder to the self-bound form and an additional decrease in N₂ absorbance, although slight, from the self-bound form the form bound with 10 wt % Methocel. There is very little difference in the PXRD spectra of the bound and unbound MIL-100(Fe), but referring back to table 1, there is a large difference in the crush strength (10.8 lb-force).

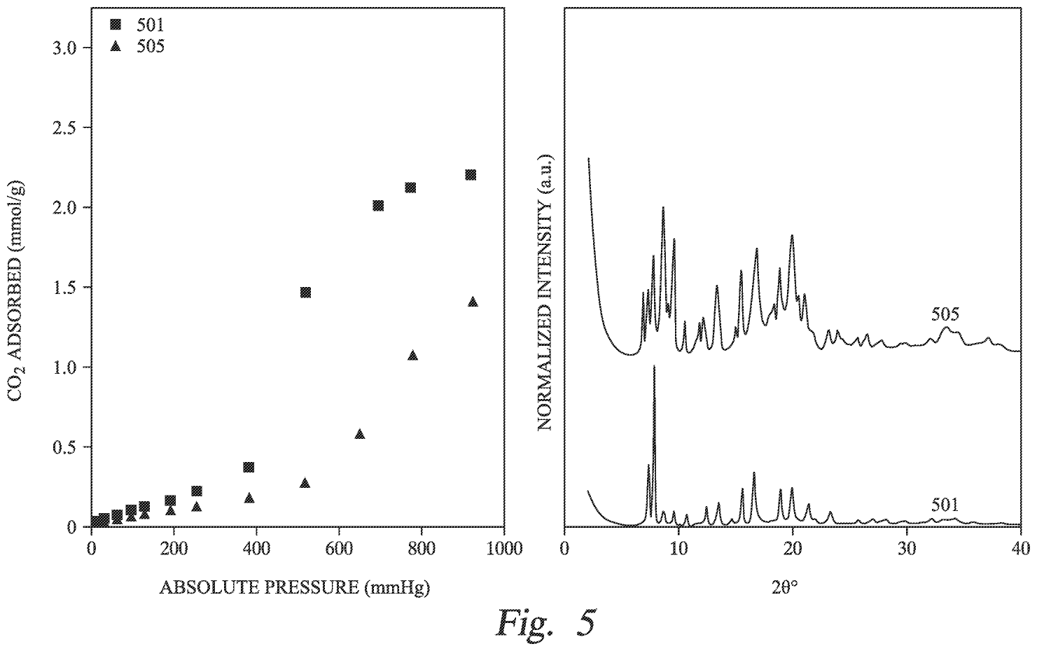

Referring now to FIG. 5, a representation of adsorption and x-ray diffraction data of ZIF-7 in bound and unbound forms with various binders. ZIF-7 is a MOF including zinc and imidazole. 501 represents ZIF-7 in a crystalline powder not bound, extruded, or shaped. 505 represents ZIF-7 with 10 wt % Methocel. There is a decreases in CO₂ absorbance from the crystalline powder to the form bound with 10 wt % Methocel. Referring back to table 1, there is a large difference in the crush strength (5.9 lb-force).

MOF-74 is not shown in the figures, but is a MOF including a divalent cation, such as Mn2+, Fe2+, Co2+, Ni2+, Cu2+, or Zn2+, and 2,5-dihyroxyterephtlaic acid.

Extrudates with Methocel preserve the bulk crystallinity of the material while retaining porosity after extrusion. As HKUST-1 is only partially water-stable, extrusions with mixtures of ethanol/water would serve to increase the porosity of the extrudate further. Extrusions with the water-stable UiO-66, the Brunauer-Emmett-Teller (BET) surface areas of the MOF is 1150 and 864 m²/g for extrudates with 10% and 20% Methocel, respectively, which compares favorably with the 1180 m²/g of the parent crystallite. Likewise, ZIF-8 retains its high surface area and crystallinity after extruding the material with Methocel, with a minimal decrease of surface area from 1800 to 1410 m²/g. Although the bulk-phase crystallinity of MIL-100(Fe) is retained after extruding with Methocel, a decrease in surface area from 1270 m2/g to 590 m²/g was observed. A similar decrease in surface area was observed in self-bound extrudates, and could be prescribed to poor stability in water, which could be alleviated with extrusions in water/ethanol mixtures. In a final example, ZIF-7 was chosen to evaluate whether Methocel is a viable binder to use with flexible materials. Upon, sufficient applied pressure, ZIF-7 experiences a gate-opening effect, which allows the ZIF-7 to be porous to CO₂. This phenomenon can be observed at a pressure of ˜500 mmHg in the CO₂ isotherm taken at 301 K where a dramatic increase in adsorption occurs in the crystallite. A similar, albeit more gradual, step in the isotherm is observed in the extrudate with Methocel, suggesting the flexibility of the material is at least partially retained. Additional extrusions were conducted using Chitosan and Cellulose Acetate as binders. Extrudates formed with these binders proved to not be mechanically robust. These polysaccharides have lower glass transition temperatures as well as lower Young's modulus compared to hydroxypropyl methylcellulose which suggests these are important factors to consider when picking a polymeric binder.

In summary, Methocel has been used as a binder with a diverse set of MOFs with various physical and chemical properties. The resulting extrudates exhibit dramatically improved mechanical strength compared to self-bound extrudates or extrudates with Al₂O₃-based binders. Many of the advantageous properties of MOFs (e.g. high surface area, crystallinity) are retained after extrusion with Methocel, and could be improved upon by working with non-aqueous solutions. Methocel-based extrusions appear to be a broad solution to obtaining MOF materials that could be used in an industrial application.

Extrusions with Polyvinylpyrollidone Binder

Table 2 provides relevant trials for a variety of MOF materials using the polyvinylpyrollidone (PVP) binder, along with a comparative sample (self-bound). The table includes data related to crush strength and surface area retention. The MOFs prepared with polymeric binders show improved crush strength without significant loss in surface area.

TABLE 2
Crush Strength and Surface Area of MOFs

| | | | | | Surface |
|---|---|---|---|---|---|
| | | | Binder | Crush | Area |
| | | | Amount | Strength | Retention |
| MOF | Comparative | Binder | (wt %) | (lb-force) | (%) |
| MOF- | Comparative | Self | 0 | — | — |
| 74(Mg) | | | | | |
| MOF- | | PVP | 10 | 4.0 | 100 |
| 74(Mg) | | | | | |
| MIL- | | PVP | 12 | 8.8 | 80 |
| 100(Fe) | | | | | |
| MIL- | | PVP | 17 | 13 | 34 |
| 100(Fe) | | | | | |
| ZIF-8 | | PVP | 6 | 2.4 | 104 |
| ZIF-8 | | PVP | 10 | 3.4 | 95.8 |

PVP is a water-soluble polymer that binds well to polar molecules due to its polarity. Extrusions can be conducted by either pre-dissolving the polymer into a gel paste or by mixing the dry powders together and subsequently wetting the materials during the mixing stage. Either method (pre-dissolving or solid mixing) results in indistinguishable extrudates, both in terms of surface area retention and crush strength. Depending on the MOF, PVP-bound extrudates produce a mechanically robust material while retaining the bulk of the surface area. Larger amounts of PVP contained in the extrudate may improve the crush strength, however, the surface area decreases as well.

Extrusions with Poly(Allylamine) Binder

Table 2 provides relevant trials for a variety of MOF materials using the poly(allylamine) (PAA) binder, along with a comparative sample (self-bound or with an Al₂O₃ binder: Versal-300). The table includes data related to crush strength and surface area retention. The MOFs prepared with polymeric binders show improved crush strength without significant loss in surface area.

TABLE 2
Crush Strength and Surface Area of MOFs

| | | | | | Surface |
|---|---|---|---|---|---|
| | | | Binder | Crush | Area |
| | | | Amount | Strength | Retention |
| MOF | Comparative | Binder | (wt %) | (lb-force) | (%) |
| UiO-66 | Comparative | Self | 0 | 0 | — |
| UiO-66 | Comparative | Versal-300 | 35 | 0 | 105 |
| UiO-66 | | PAA | 5 | 5 | 99.3 |
| MIL- | Comparative | Self | 0 | 0 | 62.3 |
| 100(Fe) | | | | | |
| MIL- | | PAA | 5 | 1.9 | 18.9 |
| 100(Fe) | | | | | |

A 20% by wt. solution of PAA (MW=17,000 g/mol) in water was used as the wetting mixture (diluting further with more water to achieve the desired polymer wt %). A well-formed extrudate was obtained when using UiO-66 due to the acid surface sites interacting with the basic amine group contained on the polymer. A respectable crush strength was obtained with very minimal amounts of PAA while completely retaining the surface area of the MOF. Crush strengths of the PAA/MIL-100(Fe) can be improved by increasing the wt % of PAA or by using larger cylinder die inserts.

Extrusions with Nafion Binder

Table 3 provides relevant trials for a variety of MOF materials using the nafion binder, along with a comparative sample (self-bound or with an Al₂O₃ binder: Versal-300). The table includes data related to crush strength and surface area retention. The MOFs prepared with polymeric binders show improved crush strength without significant loss in surface area.

TABLE 3
Crush Strength and Surface Area of MOFs

| | | | | | Surface |
|---|---|---|---|---|---|
| | | | Binder | Crush | Area |
| | | | Amount | Strength | Retention |
| MOF | Comparative | Binder | (wt %) | (lb-force) | (%) |
| UiO-66 | Comparative | Self | 0 | 0 | — |
| UiO-66 | Comparative | Versal-300 | 35 | 0 | 105 |
| UiO-66 | | Nation | 5 | 3.7 | 106 |
| MIL- | Comparative | Self | 0 | 0 | 62.3 |
| 100(Fe) | | | | | |
| MIL- | | Nation | 5 | 2 | 86.1 |
| 100(Fe) | | | | | |

A Nafion 117 solution (5 wt % in alcohol/water mixture) was used as the wetting agent in extrusions (and diluted further with water). A well-formed extrudate with respectable crush strength was obtained using UiO-66 as the active material. The surface area of UiO-66 and MIL-100(Fe) was largely sustained after the extrusion. With its hydrophobic polymer backbone, Nafion offers the possibility of achieving extrudates with hydrophobic surfaces.

Extrusions with Polyvinyl Acetate Binder

Table 4 provides relevant trials for a variety of MOF materials using a polyvinyl acetate (PVAc) binder and may further include a polyvinyl alcohol (PVA) binder. The table includes data related to crush strength and BET surface area. The MOFs prepared with polymeric binders show improved crush strength without significant loss in surface area.

TABLE 4
Crush Strength and Surface Area of MOFs

| | | | | | BET |
|---|---|---|---|---|---|
| | | PVAc/ | PVAc | Crush | Surface |
| | | Deionized | amount | Strength | Area |
| MOF | Comparative | water ratio | (wt %) | (lb-force) | (m²/g) |
| ZIF-8 | — | 50/50 | 0 | 6.6 | 978 |
| ZIF-8 | — | 25/75 | 3 | 17 | 1190 |
| HKUST-1 | — | 25/75 | 0 | 13 | 626 |
| HKUST-1 | — | 25/75 | 0 | 6.6 | 660 |
| HKUST-1 | — | 25/75 | 2 | 27 | 905 |

The MOF extrusion was accomplished in a ram extruder after the extrusion mixture was prepared in a device along the lines of U.S. Pat. No. 10,307,751 B2. The binder was polyvinyl acetate (Elmer's glue) and the glue was diluted upfront with deionized water according to the values shown in the table. In some cases polyvinyl alcohol was added as well. After the mixture was prepared to a satisfactory rheology the mixture was extruded in a ram extruder through inserts that allowed a plurality of extrusion channels of a ⅛″ in diameter. The extrudates were then dried at 150° C. overnight. The surface area by BET was measured as well as the crush strength. The crush strength values were all very acceptable and showed similar strength to standard commercial inorganic alumina extrudates

Overall, it has been discovered that the combination of MOF materials with polymeric binders produces a MOF extrudate with greatly improved mechanical stability, including crush strength. Additionally, the inclusion of polymeric binders does not negatively affect the crystallinity or the surface area of the parent material. This has been shown with a variety of polymeric binders and a variety of MOF materials with different metal nodes, pore sizes, and crystalline structures. The MOF extrudates have sufficient mechanical strength to be used in a variety of industrial applications including as catalysts, support for catalysts, sorption, storage of fluids, desiccants, ion exchanger materials, molecular sieves (separators), materials for chromatography, materials for the selective release and/or uptaking of molecules, molecular recognition, nanotubes, nano-reactors. Many combinations of MOF materials and polymeric binders have been demonstrated to provide improved mechanical stability and sufficient crush strength for industrial use, however, this disclosure provides for combinations beyond what has specifically been described.

The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of this disclosure, additionally, they do not exclude impurities and variances normally associated with the elements and materials used.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, a range includes every point or individual value between its end points even though not explicitly recited. Thus, every point or individual value may serve as its own lower or upper limit combined with any other point or individual value or any other lower or upper limit, to recite a range not explicitly recited.

All documents described herein are incorporated by reference herein, including any priority documents and/or testing procedures to the extent they are not inconsistent with this text. As is apparent from the foregoing general description and the specific embodiments, while forms of this disclosure have been illustrated and described, various modifications can be made without departing from the spirit and scope of this disclosure. Accordingly, it is not intended that this disclosure be limited thereby. Likewise whenever a composition, an element or a group of elements is preceded with the transitional phrase “including,” it is understood that we also contemplate the same composition or group of elements with transitional phrases “consisting essentially of,” “consisting of,” “selected from the group of consisting of,” or “is” preceding the recitation of the composition, element, or elements and vice versa. The processes and materials disclosed may be practiced in the absence of any element which is not disclosed herein.

While the present disclosure has been described with respect to a number of embodiments and examples, those skilled in the art, having benefit of this disclosure, will appreciate that other embodiments can be devised which do not depart from the scope and spirit of the present disclosure.

1. A composition comprising:
a metal-organic framework material; and
a polymeric binder;
the composition having a bulk crush strength of about 2.5 lb-force or greater.

2. The composition of claim 1, wherein the composition is an extrudate, granule, or shaped body, and wherein shaping of the metal-organic framework material occurs at pressures greater than about 300 psig.

3. The composition of claim 1, wherein the metal-organic framework material comprises an organic ligand comprising one or more of:
an alkyl group substructure having from 1 to 10 carbon atoms; or
an aryl group substructure having from 1 to 5 aromatic rings; and
wherein the one or more substructures each have at least two X groups, and wherein X is a functional group configured to coordinate to a metal or metalloid.

4. The composition of claim 3, wherein the metal-organic framework material comprises an organic ligand comprising an alkylamine substructure having from 1 to 10 carbon atoms or an arylamine or nitrogen-containing heterocycle substructure having from 1 to 5 aromatic rings; and wherein the substructure(s) each have at least two X groups, and wherein X is a functional group configured to coordinate to a metal or metalloid.

5. The composition of claim 3, where each X is independently selected from the group consisting of neutral or ionic forms of CO₂H, OH, SH, OH₂, NH₂, CN, HCO, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, CH(SH)₂, C(SH)₃, CH(NH₂)₂, C(NH₂)₂, CH(OH)₂, C(OH)₃, CH(CN)₂, C(CN)₃, nitrogen-containing heterocycles, sulfur-containing heterocycles, and combination(s) thereof, wherein R is an alkyl group having from 1 to 5 carbon atoms or an aryl group consisting of 1 to 2 phenyl rings.

6. The composition of claim 3, wherein the organic ligand is selected from the group consisting of 1,3,5-benzenetricarboxylate, 1,4-benzenedicarboxylate, 1,3-benzenedicarboxylate, biphenyl-4,4′-dicarboxylate, benzene-1,3,5-tris(1H-tetrazole), acetylene-1,2-dicarboxylate, naphtalenedicarboxylate, adamantanetetracarboxylate, benzenetribenzoate, methanetetrabenzoate, adamantanetribenzoate, biphenyl-4,4′-dicarboxylate, imidazole, 2,5-dihydroxy-1,4-benzendicarboxylic acid, 4,4′-dihydroxy-(1,1′-biphenyl)-3,3′-dicarboxylic acid derivatives thereof, and combination(s) thereof.

7. The composition of claim 3, wherein the metal-organic framework material comprises a metal ion selected from the group consisting of Be²⁺, Mg²⁺, Ca²⁺, Sr²⁺, Ba²⁺, Sc³⁺, Y³⁺, Ti⁴⁺, Zr⁴⁺, Hf⁴⁺, V⁴⁺, V³⁺, V²⁺, Nb³⁺, Ta³⁺, Cr³⁺, Mo³⁺, W³⁺, Mn³⁺, Mn²⁺, Re³⁺, Re²⁺, Fe³⁺, Fe²⁺, Ru³⁺, Ru²⁺, Os³⁺, Os²⁺, Co³⁺, Co²⁺, Rh²⁺, Rh⁺, Ir²⁺, Ir⁺, Ni²⁺, Ni⁺, Pd²⁺, Pd⁺, Pt²⁺, Pt⁺, Cu²⁺, Cu⁺, Ag⁺, Au⁺, Zn²⁺, Cd²⁺, Hg²⁺, Al³⁺, Ga³⁺, In³⁺, Tl³⁺, Si⁴⁺, Si²⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, and Bi⁵⁺, Bi³⁺, Bi⁺, and combination(s) thereof.

8. The composition of claim 1, wherein the metal-organic framework material is selected from the group consisting of HKUST-1, UiO-66, ZIF-8, ZIF-7, MIL-100, MOF-74, MOF-274, and combination(s) thereof.

9. The composition of claim 1, wherein the polymeric binder comprises a biopolymer or a derivative thereof, selected from the group consisting of xanthan gum, scleroglucan, hydroxyethylated cellulose, carboxymethylcellulose, methylated cellulose, hydroxypropylated cellulose, cellulose acetate, lignosulphonates, galactomannan, cellulose ethers, derivatives thereof, and combination(s) thereof.

10. The composition of claim 1, wherein the polymeric binder comprises a polar polymer selected from the group consisting of a polyvinyl amide, a polyvinyl amine, a polyvinyl alcohol, a polyvinyl ester, a polyamide, a polyester, a polyether, a polyacrylate, a polycarbonate, or combination(s) thereof.

11-14. (canceled)

15. The composition of claim 1, wherein the polymeric binder comprises a styrenic polymer.

16. The composition of claim 1, wherein the polymeric binder comprises a polysiloxane.

17. The composition of claim 1, wherein the polymeric binder comprises a halogenated polymer.

18. The composition of claim 1, wherein the composition has a comparative BET surface area of from about 70% to about 100%.

19. The composition of claim 1, wherein the composition has a porosity of from about 70% to about 100% of the metal-organic framework material.

20. The composition of claim 1, wherein the composition has a pore size of from about 2 Å to about 25 Å.

21. A process for producing a metal-organic framework extrudate, the process comprising:
mixing a metal-organic framework material, a polymeric binder, and optionally a solvent to form a mixture; and
extruding the mixture to form a metal-organic framework extrudate.

22. The process of claim 21, further comprising maturing the metal-organic framework extrudate at a temperature of about 20° C. to about 100° C. for a period of about 30 minutes or greater.

23. The process of claim 21, further comprising calcining the metal-organic framework extrudate at a temperature of about 100° C. to about 300° C. for a period of about 1 hour or greater.

24. The process of 21, wherein the mixture comprises from about 20 wt % to about 70 wt % solids, based on the total weight of the mixture.

25. The process of 21, wherein the solvent is selected from the group consisting of water, alcohols, ketones, amides, esters, ethers, nitriles, aromatic hydrocarbons, aliphatic hydrocarbons, and combination(s) thereof.

26. The composition of claim 1, wherein the polymeric binder comprises a polyolefin, selected from the group consisting of a polyethylene, a polypropylene, an ethylene propylene diene terpolymer, and a random copolymer of at least one of propylene and ethylene and one or more of butene and/or hexene.
